(19) United States
(12) Patent Application Publication
(10) Pub. No.: US 2017/0024760 A1
(43) Pub. Date: Jan. 26, 2017

(54) SYSTEM AND METHOD FOR BRAND AFFINITY CONTENT DISTRIBUTION AND OPTIMIZATION

(71) Applicant: VERITONE, INC., Newport Beach, CA (US)

(72) Inventors: Ryan Steelberg, Irvine, CA (US); Chad Steelberg, Newport Beach, CA (US)

(21) Appl. No.: 15/150,391

(22) Filed: May 9, 2016

Related U.S. Application Data
(63) Continuation of application No. 12/590,668, filed on Nov. 12, 2009, now abandoned.
Application No. 12/590,668 is a continuation-in-part of application No. 12/144,194, filed on Jun. 23, 2008.
Application No. 12/144,194 is a continuation-in-part of application No. 11/981,646, filed on Oct. 31, 2007.
Application No. 11/981,646 is a continuation-in-part of application No. 11/981,837, filed on Oct. 31, 2007, now Pat. No. 7,809,603.
Application No. 12/144,194 is a continuation-in-part of application No. 12/072,692, filed on Feb. 27, 2008, now abandoned.
Application No. 12/072,692 is a continuation-in-part of application No. 12/079,769, filed on Mar. 27, 2008.
Application No. 12/079,769 is a continuation-in-part of application No. 12/042,913, filed on Mar. 5, 2008, now abandoned.
Application No. 12/042,913 is a continuation-in-part of application No. 12/072,692, filed on Feb. 27, 2008, now abandoned.
Application No. 12/072,692 is a continuation-in-part of application No. 11/981,646, filed on Oct. 31, 2007.
(60) Provisional application No. 61/114,695, filed on Nov. 14, 2008.
(60) Provisional application No. 60/993,096, filed on Sep. 7, 2007.

(51) Int. Cl. G06Q 30/02

(52) U.S. Cl. CPC G06Q 30/0244; G06Q 30/0256

(57) ABSTRACT

An endorsed advertising engine, system and method, which includes at least one vault having media assets, a recommendation engine that matches the media assets from the vault with at least one requested creative, and a delivery engine that integrates the requested creative with the matched media assets from the vault.

### CROSS-REFERENCE TO RELATED APPLICATIONS

This application is a continuation of U.S. patent application Ser. No. 12/590,668 entitled “System and Method For Brand Affinity Content Distribution and Optimization,” filed Nov. 12, 2009, which claims the benefit of U.S. Provisional Application No. 61/114,695 entitled “System and Method For Brand Affinity Content Distribution and Optimization,” filed Nov. 14, 2008, and is a continuation-in-part of U.S. patent application Ser. No. 12/144,194, entitled “System and Method For Brand Affinity Content Distribution and Optimization”, filed Jun. 23, 2008, the entire disclosures of which are incorporated by reference herein as if set forth in their entirety.

U.S. patent application Ser. No. 12/144,194 is: a continuation-in-part of U.S. patent application Ser. No. 11/981,646, entitled “Engine, System and Method for Generation of Brand Affinity Content”, filed Oct. 31, 2007; a continuation-in-part of U.S. patent application Ser. No. 11/981,837, entitled “An Advertising Request And Rules-Based Content Provision Engine, System and Method”, filed Oct. 31, 2007; a continuation-in-part of U.S. patent application Ser. No. 12/072,692, entitled “Engine, System and Method For Generation of Brand Affinity Content, filed Feb. 27, 2008; and a continuation in part of U.S. patent application Ser. No. 12/079,769, entitled “Engine, System and Method for Generation of Brand Affinity Content,” filed Mar. 27, 2008.

U.S. patent application Ser. No. 11/981,837 claims priority to U.S. Provisional Application Ser. No. 60/993,096, entitled “System and Method for Rule-Based Generation of Brand Affinity Content,” filed Sep. 7, 2007, and is related to U.S. patent application Ser. No. 11/981,646.

U.S. patent application Ser. No. 12/079,769 is a continuation-in-part of U.S. patent application Ser. No. 12/042,913, entitled “Engine, System and Method for Generation of Brand Affinity Content,” filed Mar. 5, 2008, which is also a continuation-in-part of U.S. patent application Ser. No. 12/072,692.

U.S. patent application Ser. No. 12/072,692 is a continuation-in-part of U.S. patent application Ser. No. 11/981,646.

The disclosures of which are incorporated by reference herein as if each is set forth in its entirety.

### FIELD OF THE INVENTION

The present invention is directed to an advertising engine and, more particularly, to an engine for generation of brand affinity content, and a method of making and using same.

### BACKGROUND OF THE INVENTION

High impact advertising is that advertising that best grabs the attention of a target consumer. A target consumer is the ideal customer for the particular goods being advertised, from a socio-economic perspective, from a morals and values perspective, from an age or interest level perspective, or based on other similar factors. The impact on an ideal customer of any particular advertisement may be improved if an advertisement includes endorsements, sponsorships, or affiliations from those persons, entities, or the like from whom the ideal target consumer is most likely, or highly likely, to seek guidance. Factors that will increase the impact of an endorser include the endorser's perceived knowledge of particular goods or in a particular industry, the frame or popularity of the endorser, the respect typically accorded a particular endorser or sponsor, and other similar factors.

Consequently, the highest impact advertising time or block available for sale will generally be time that is associated, such as both within the advertisement and within the program with which the advertisement is associated, with an endorser most likely to have high impact on the ideal target customer. However, the existing art makes little use of this advertising reality.

Thus, there exists a need for an engine, system and method that allows for the obtaining of an endorsement or sponsorship, in the aforementioned high-impact circumstances, either from a specific individual, a specific entity, an affinity brand, a marketing partner, or a sponsor.

### SUMMARY OF THE INVENTION

The present invention includes at least an endorsed advertising engine, system and method, which includes at least one vault having media assets, a recommendation engine that matches the media assets from the vault with at least one requested creative, and a delivery engine that integrates the requested creative with the matched media assets from the vault. Creatives served thereby may include continuity as between the user's interests, a landing page, such as for an advertisement, an endorser of the creative, a media asset included in the creative, and other content within the creative, for example.

Thus, the present invention provides an engine, system and method that allows for the obtaining of an endorsement or sponsorship, in the aforementioned high-impact circumstances, either from a specific individual, a specific entity, an affinity brand, a marketing partner, or a sponsor.

### BRIEF DESCRIPTION OF THE FIGURES

The present invention will be described hereinbelow in conjunction with the following figures, in which like numerals represent like items, and wherein:

FIG. 1 illustrates an exemplary embodiment of the present invention;

FIG. 2 illustrates an exemplary embodiment of the present invention;

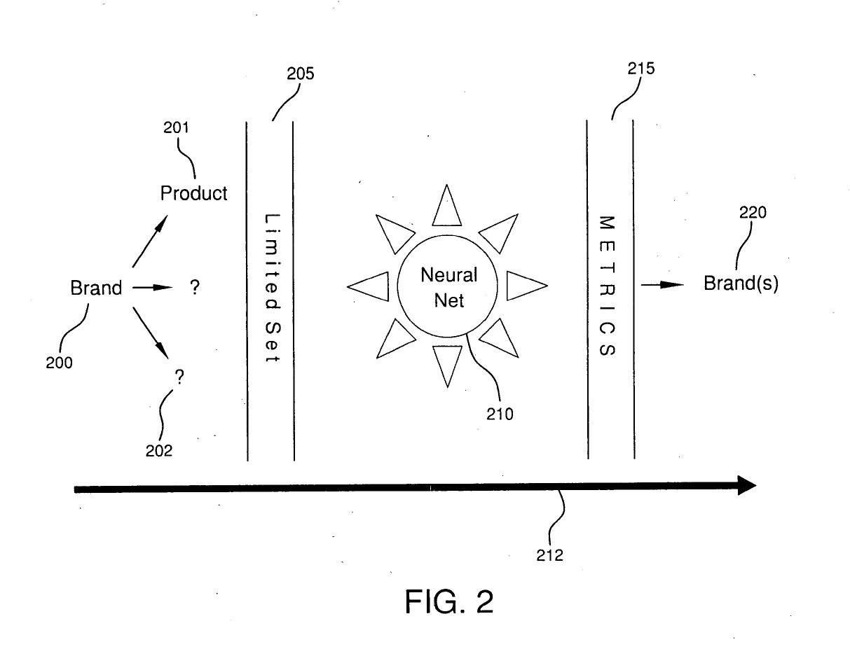

FIG. 3 illustrates an exemplary embodiment of the present invention;

FIG. 4 illustrates an exemplary embodiment of the present invention;

FIG. 5 illustrates an exemplary embodiment of the present invention;

FIG. 6 illustrates an exemplary embodiment of the present invention; and

FIG. 7 illustrates an exemplary embodiment of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical advertising engines, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the frame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

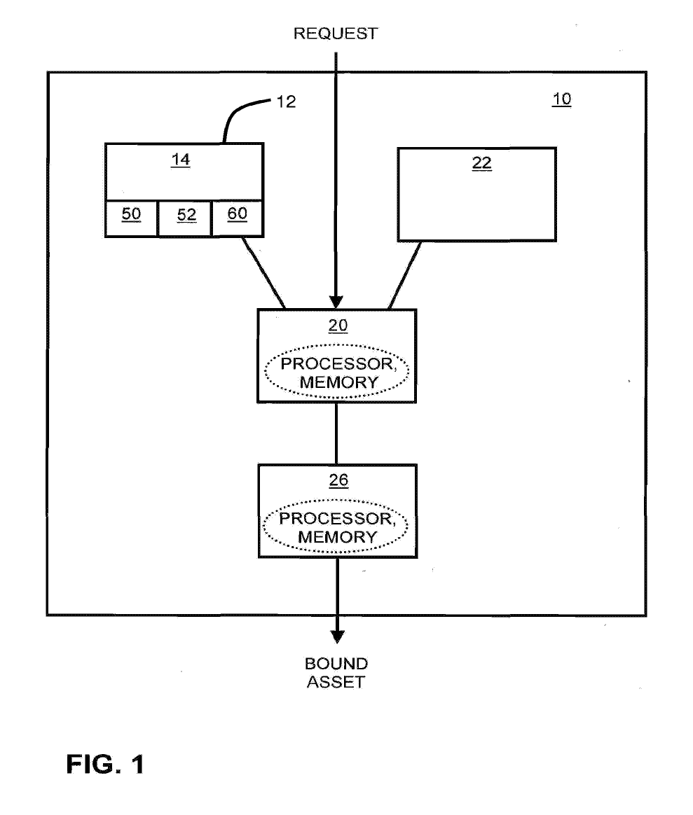

At present, there is a need for a platform or engine to allow for the obtaining of an endorsement, or endorsed ad, in any of the above circumstances, either from a specific individual, a specific entity, an affinity brand, a marketing partner, or a sponsor. In the present invention, an endorsed advertising engine 10, such as that illustrated in FIG. 1, may include a vault 12 that provides media assets 14 and integration of media assets without need of involving the media assets for permission, a brand association or recommendation engine 20 that may, by creative, by market, by brand affinity, by user request, or otherwise match media assets from the vault with an creative/ad 22, and a delivery engine 26 capable of integrating a requested ad 22 with the media asset 14 from the vault 12, late stage binding of the ad 22 and media asset 16 upon delivery to strongest target consumers, and delivery of the ad 22 and the dynamic media asset 16 from the vault to an advertiser or advertising server, which then places the mash up of the ad and media asset. Ad requests 22 may be made via an “ad wizard” using ad templates, as will be apparent to those skilled in the art.

The vault captures certain brands and information related thereto in a common database, such as all major league baseball past and present players, including statistics, video, and pictures of those players affiliated with the names of those players, in addition to any endorsement limitations on those players. The vault may include media assets that may be associated with audio-visual works. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling may provide for local or national focus and maintained in the vault as an associated media asset with a particular brand, and best matches for certain brands may be selected according to such polling results. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

Thus, the recommendation engine may passively or actively inform of the best endorsement matches for a particular user's ads, based on any number of factors. Upon assessment of good matches for the requesting brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

The delivery engine 26 may integrate a requested ad with the media asset from the vault pursuant to the actions by the recommendation engine, and can place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as with the improvement in later stage tracking for improved ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Improvement in later stage tracking for improved ad targeting may be enabled through the delivery engine 26 and will allow for greater efficiency the trafficking of ads during or after or with or without interface with the delivery engine 26. Efficiency may be obtained by tracking, for example, the data intelligence for use with the delivery of the creative. By way of non-limiting example, data intelligence may include click-thru rate, post-click conversion rate, post-impression activities, as well as geography, demographic and like information. Gathered data intelligence may be used as individual properties in conjunction with each other to form or produce the level of intelligence needed to achieve the desired efficiencies. By way of further example, data intelligence may also include information regarding the number of impressions an ad has received, the elapsed time between an impression or a click.

Utilizing the data intelligence will allow the delivery engine 26 to optimize targeting to new and past targets. Optimization may include efficiencies of time and control over redundancies and ad targeting. Optimization will allow for the prediction of probable impressions or clicks that a certain ad or creative may receive when, for example, pointed towards certain factors, such as demographic and geography, for example. A prediction may also be made regarding the efficiency of paid searches and may be further contrasted with, for example, display ads. Such information as drawn from the data intelligence may also allow for the higher success rates related to redundant ad placement based on the prior behavior of a particular audience. The same can be true for the avoidance of redundancy when, for example, data intelligence may be used to keep certain ads or creatives from repeatedly reaching an audience with, for example, low click-through rates. Redundancy avoidance may also include the avoidance of competing ads or creatives, whether or not placed for the same entity.

The delivery engine 26 may also choose to deactivate and/or modify certain creatives based on data intelligence and/or user direction. By way of non-limiting example, the data intelligence may be collected from several ad or creative types over any number of varying media formats, allowing for even more sophisticated optimization based on the allocation of impressions and clicks in the various media formats. Media formats may include, but are not limited to, internet, t.v., radio, mobile devices, kiosks, billboards, product placements, and print. By further way of non-limiting example, data intelligence gathered during a run of a creative on the radio may effect the play of an ad on the internet. The delivery engine 26 may additionally allow for the interplay between data intelligence and real time metrics or community-based information. This real time intelligence gathering may also be used to calibrate a campaign(s) of multiple ads or creatives. By way of non-limiting example only, a campaign of with several creative versions may be measured based on gathered data intelligence and optimized to improve, for example, click-through. Such optimization may be done in real time and over multiple media types. The optimization may, by way of further non-limiting example, call for the addition of ads or creatives not currently apart of the campaign(s). Thus suggesting what type of ads or creatives are required for maximum optimization regardless of whether or not the ads or creatives reside in inventory.

Optimization of ads and creatives increases the value of ad and creative inventory and may, for example, provide for greater value pre and post delivery. The data intelligence may also allow for real-time valuations based on pre-existing and predicted variables, thus maximizing the value of the placed ad or ad/creative inventory. Value can be also maximized for premium and non-premium content. Functionality within the delivery engine 26 may also allow for variable rate sampling and frequency cap forecasting.

Because the bids for advertising time in the present invention may vary as discussed above, the present invention lends itself to auction-style placement of advertising, in which bids are solicited for particular locations, times, or blocks of advertising. Auctions may be held, for example, on line, and may be broken down by media outlet type of ad (i.e. television, internet, etc.), product type of ad, or in any similar manner.

There are a myriad possibilities for the interaction between the properties resident in the vault of the present invention, the recommendation engine that recommends properties in the vault in the present invention, proposed creatives/advertisements, and the delivery of creatives/advertisements to prospective consumers. For example, the vault and or recommendation engine of the present invention may be under the control of a particular party, whereas the rules apply to certain advertisements or creatives, and/or the delivery engine that delivers the final creatives and/or advertisements, may be under the control of the same or a different party. Thus, the exemplary embodiments of the present invention discussed hereinbelow are discussed without regard to the controlling entity of each aspect of the invention, but those of ordinary skill in the pertinent arts will appreciate that different aspects of the present invention may be controlled by a single party or multiple parties up to and including a time of presentation of creatives or advertisements to a consumer or consumers. Thereby, the present invention may allow for practically unlimited numbers of interactions, such as wherein a particular product simply requests an advertisement for delivery at a certain time, and in a certain place, and involving any sponsor that falls within a requested category, such as sports, and the platform of the present invention may allow for the recommendation engine receiving the request to access the vault, find a sound byte or video of any party or parties meeting the requested criteria, and only that vault item may ultimately be delivered by the recommendation engine to a delivery engine. In such an embodiment, the delivery engine, which may be controlled by a different party, may bind a submitted creative or advertisement bound together with the vault item forwarded by the recommendation engine, assuming that the delivery engine is allowed to make such a binding in accordance with the rules relating to the vault item, which rules may be resident in a rules engine controlled by the same or yet another different party.

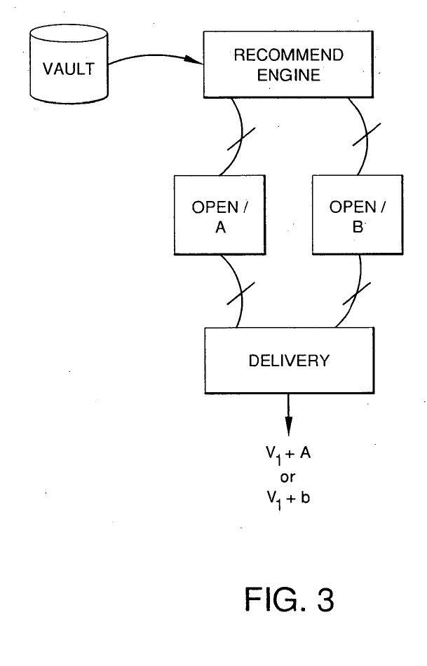

Thus, in a specific exemplary embodiment of the present invention herein referred to as a late binding embodiment, as illustrated in FIG. 3, a recommendation engine receives a request for vault items one and two, herein referred to as V1 and V2, to be produced with content A and B, respectively. It is noted, with respect to FIG. 3, that content A and B are independently delivered to a delivery engine that ultimately interfaces with consumers. Although content A and B may be delivered to the recommendation engine, as will be understood by those of skill in the art, FIG. 3 is of note in that content A and B need not be delivered to the recommendation engine in order for the recommendation engine to obtain the desired properties from the vault. Thus, continuing with the illustrative embodiment of FIG. 3, the recommendation engine obtains properties V1 and V2, presumably in accordance with the request made of the recommendation engine meeting any rules applicable to allow one to obtain the properties V1 and V2.

In this exemplary embodiment, content A and content B have been delivered, or will be delivered, to the delivery engine, and, responsive to the request, the recommendation engine delivers content V1 and V2 for binding with content A and content B, respectively. In such an embodiment, content A and content B may each respectively have created a “space” for the ultimate inclusion of content V1 and V2, respectively. Finally, in the illustrated embodiment, upon receipt of an advertisement request that would typically lead to the delivery of advertisement A, content V1 plus A is instead produced by the delivery engine. Similarly, in the event that an advertisement correspondent to B would typically be produced, the delivery engine of the instant embodiment will instead bind and deliver V2 plus B.

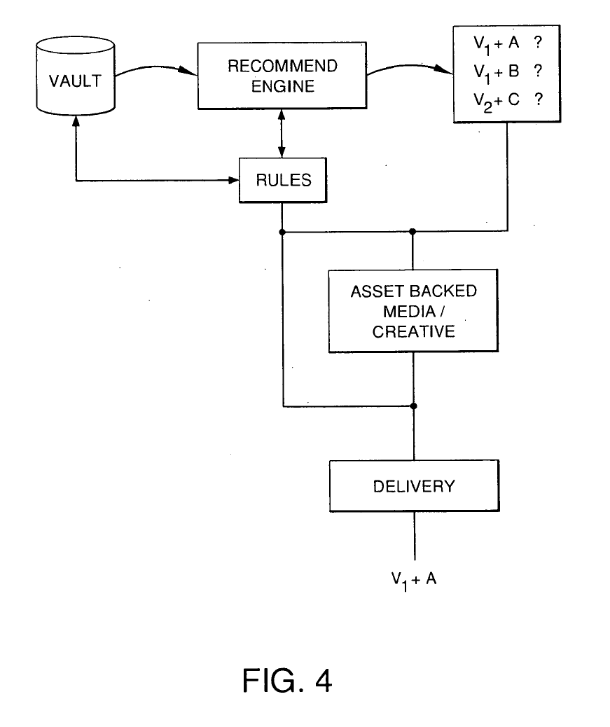

In an additional exemplary embodiment of the present invention illustrated in FIG. 4, and herein referred to as a prebind, the recommendation engine again receives a request for the association of content V1 and V2 with certain other content. However, in this embodiment and in contrast to the embodiment of FIG. 3, the recommendation queries, in part by accessing rules in a rules engine that govern the binding of V1 and V2 to particular other types of content, whether or not content V1 may be bound to content A, or content B, or whether content V2 may be bound to content C. In the event that one or more of such bindings are allowable in accordance with the recommendation request and the rules engine, such bindings are made to create what is herein referred to as asset backed media, which constitutes the union of the vault asset or vault content, with the content to which the union of the vault content was requested. In the illustrated embodiment of FIG. 4, this asset backed media is again passed through the rules engine to ensure compliance of the binding with the applicable rules of the rules engine, although those skilled in the art will understand that, in certain embodiments, this second application of rules from the rules engine may not be performed. Ultimately, the allowable union of the illustrated embodiment, which in this case is V1 plus A, is delivered to the delivery engine, which may subsequently deliver this union of V1 plus A to a consumer for whom advertisement A may be applicable. Of course, in this exemplary embodiment, content A may not be an advertisement, but may in fact be any type of creative, publication, media, or the like.

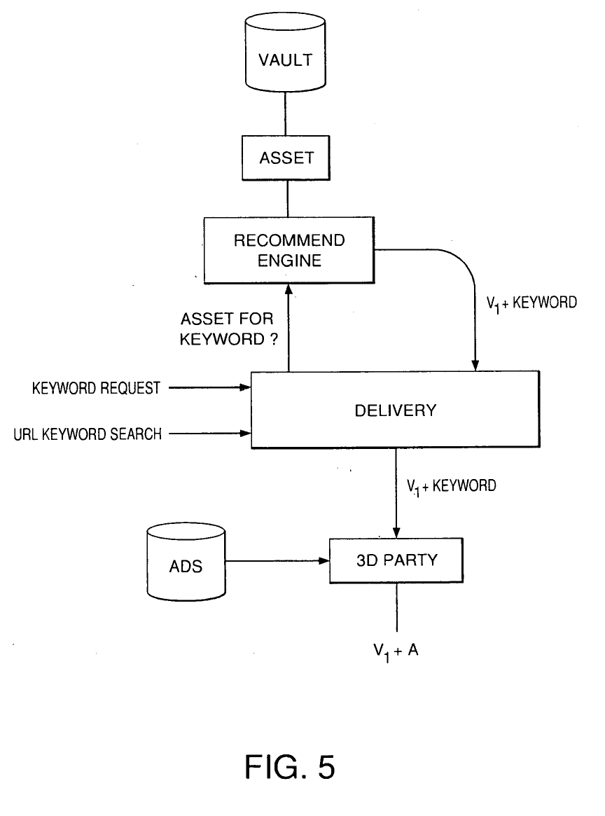

FIG. 5 illustrates an additional exemplary embodiment of the present invention, herein referred to as a sponsored page, or sponsored link, binding. In such an embodiment, for example, the generator of a page of content, or links of content, may wish that page or those links to be sponsored in the entirety by a relevant sponsor. Such a sponsor may, for example, make the effected page more relevant to consumers of the information on the page. In the embodiment illustrated in FIG. 5, the delivery engine delivers key word associations, rather than bound advertisements or creatives. The delivery engine illustrated further receives a key word request, and/or a URL key word search. The delivery engine then makes a request to the recommendation engine as to whether the recommendation engine has, located in the vault, an asset correspondent to the particular key word or key words or key word search of interest. The recommendation engine in this embodiment again accesses the vault and, if present, obtains the relevant asset or assets, which it subsequently binds with the requested key word or key words, respectively. This binding of vault asset V1 and key word A, as illustrated in FIG. 5, is then delivered to the delivery engine. The delivery engine then delivers asset V1 bound with the key word, either with the page or link or links, or to a third party entity. Either the delivery engine, or this third party entity, may then create the union of a secondary advertisement or creative with asset V1 to be produced to a consumer of the subject web page or link. It is almost goes without saying that, although the content V1 is dependent on the key word delivered to the delivery engine, such key word need not be delivered to the consumer, only the content, namely content V1, associated with that key word need be delivered to the consumer. Thereby, the present invention may be employed to add relevant sponsors to topical web pages on the internet. Likewise, relevant sponsors may be produced for publications, and relevant sponsored advertisements may similarly be produced on web pages and/or with publications.

For example, an entity publishing an online golf digest in the present invention may use the present invention to produce vault assets relating to Tiger Woods alongside the golf digest publication. Obviously, Tiger Woods may allow to reside in the vault certain assets related to Tiger Woods that are available for a fee, and/or other assets that are available at no fee in the event certain rules engine based criteria are met. Thus, in the aforementioned example, Tiger Woods may allow use of his likeness alongside the sited golf digest publication without payment of a fee, or with payment of a fee different from the fee Tiger Woods might receive for the use of content related to him in an advertising based embodiment. Likewise, the present invention may be used to produce relevant assets alongside or on the pages of, for example, online embodiments of newspapers and magazines.

Further, it is known in the existing art to engage in a myriad of different types of advertisement online. Two such advertisement types are: a search advertising model, in which a user undertakes to search for a good or service of interest and receives, as part of or as indicated with a search result(s), advertisements relevant to purchasing the good or service for which the search was made and/or to purchasing goods or services related to the good or service for which the search was made; and a display advertising model, in which a user is actively viewing a web site and receives, as part of the web site under review, advertisements for the purchase of goods or services relevant to the content of the web site under review. Needless to say, the former operates on the principal that if a user searches for a good or service, he/she would like to buy that good or service, and the latter operates on the principal that if a user is interested enough in the content of a web site to view that web site, he/she is also likely interested in buying goods or services related to the content of that web site.

The display advertising model mentioned hereinabove is typically embodied as banner on a web site. For example, such banners may appear above, below, to the left, or to the right of the content being viewed, but typically do not impinge upon the content being viewed. The search advertising model mentioned hereinabove is typically embodied as advertisements/banners placed proximate to search results on the search results page responsive to the user search. For example, such advertisements may appear along a right hand side of a search results page, while the search results are displayed along the left hand side of the same search results page.

As discussed immediately above, it is necessarily the case that the correlations performed between the user's searched or viewed content and the advertisements provided will increase the relevance of, and thus the response to, the advertisements. However, such responses in the form of either clicks on the advertisements or purchases made through the advertisement link, once obtained at a particular rate, cannot be further improved by the relevance of the advertisements produced. Rather, the only manner to improve the response rate once relevant advertisements are produced is to improve the advertisements themselves based on the users viewing the advertisements.

The present invention provides such improved response advertisement through the provision of brand affiliations with the goods and services being advertised, as discussed herein throughout. As discussed, the present invention allows for the production of advertisements having brand sponsorship that is optimized to the market sought. That is, the brand sponsor selected for an advertised good or service is, though the use of the present invention, selected to best correspond to the characteristics of the purchaser sought by the advertisement.

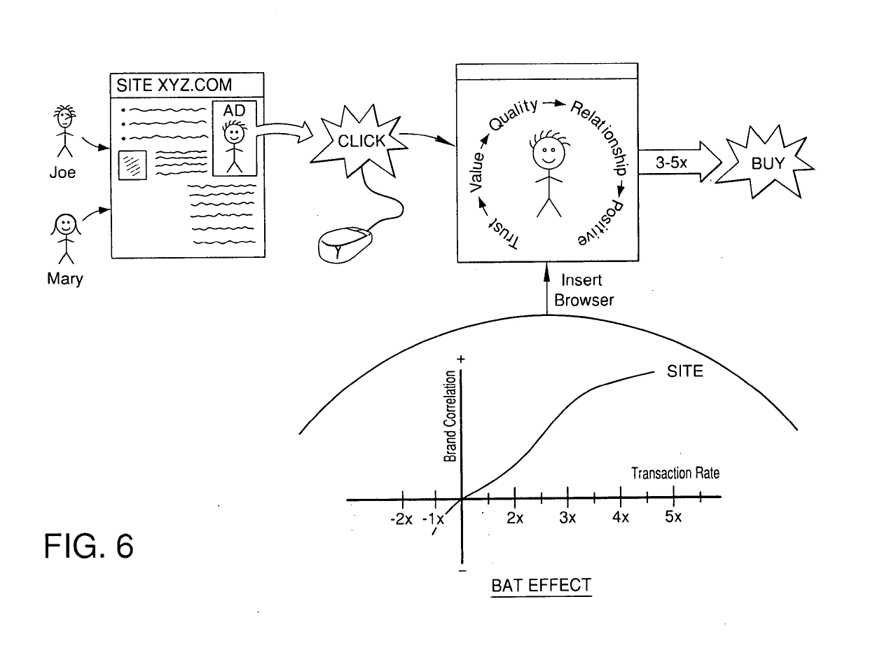

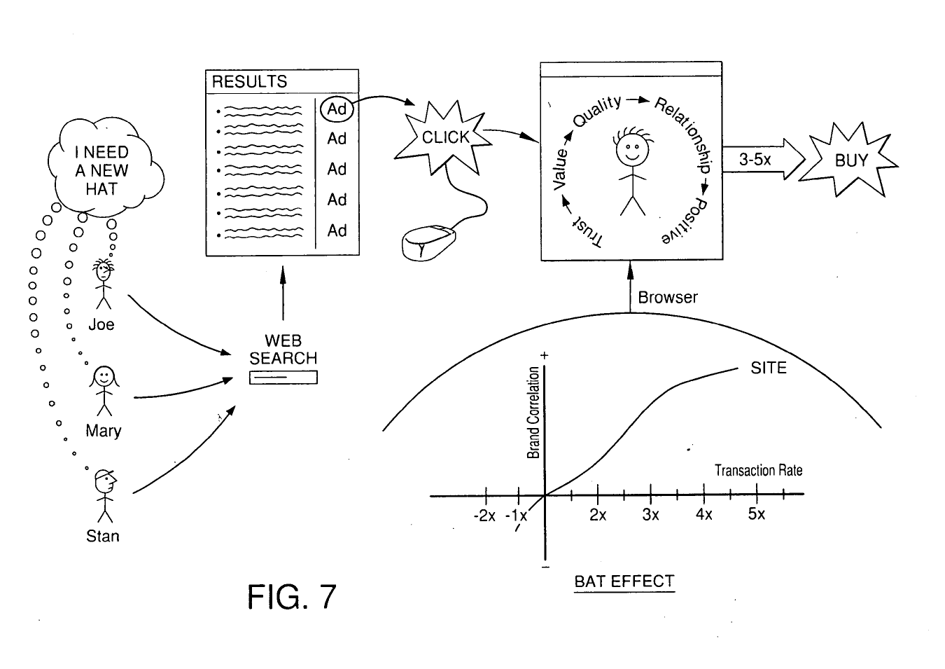

This effect is illustrated with respect to FIGS. 6 and 7. FIG. 6 illustrates the effect of the present invention with regard to a search advertising model, and FIG. 7 illustrates the effect of the present invention with respect to a display advertising model. In each Figure, a brand sponsor has been selected who will indicate, to the user for whom the advertisement is deemed most relevant, trust, quality, value, a relationship to the user, and/or an overall positive feeling. The sponsor is either selected by the advertiser in the present invention for inclusion with the subject advertisement, based on the profile of a desired purchaser and the characteristics of that sponsor as they relate to that profile, which relation is set forth or suggested by the present invention, or the sponsor is selected by the present invention for inclusion in or with the subject advertiser's advertisement based on a desired responder profile for the advertisement entered by the advertiser to the engine of the present invention.

As illustrated graphically in FIGS. 6 and 7, a positive correlation of a brand sponsor to a brand, which is necessarily also a correlation of a brand sponsor to those purchasers most interested in buying the subject brand, correlates positively to a increased transaction rate. In other words, to the extent the present invention provides brand affiliations, sponsorships, and the like that are well-suited to the sponsored brand, that brand will show an increase in the number of users who are shown that advertisement and that either click that advertisement or purchase that brand through that advertisement. It is estimated that the increase in the desired response rate in accordance with the use of the present invention may typically be a 3 to 5 times increase, based on the increased positive correlation between the sponsored brand and the brand sponsor provided by the present invention, although those skilled in the art will understand that more or less improvement in the transaction rate may occur based on the implementation of the present invention.

Thus, in accordance with the present invention, and as illustrated in FIGS. 6 and 7, an increased correlation of a brand sponsor to a sponsoring brand, and thus an increased correlation of a sponsoring brand to a desired purchaser's profile, is provided. This increased correlation generates an improved transaction rate in accordance with the present invention, for at least a search advertising model and a display advertising model.

The Internet is used by millions of people everyday, such as to purchase goods and services, or to find a company or individual to help or advise on products or services that may be available. If a product or service is not visible to potential customers, then a massive opportunity may be missed to win business and increase profitability.

Search engines offer a service to both consumers and advertisers, which service includes allowing contact with a desired audience in a much targeted and increasingly cost effective manner. Based on keywords, search engine result pages have high exposure rates wherein each title makes an impression. For example, creating catchy titles as click triggers, desirable content when the visitor lands on pages, an intriguing design may help attract sales to a “window shopper” visitor, that is, one who is exploring the web principally for emotional or intellectual stimulation.

Pay per click advertising is an advantageous way to get desirable visitors to a website. Most major search providers offer a pay per click service wherein advertisements may be displayed in highly exposed areas of search results. Each time a customer clicks on the advertisement in such an embodiment, a small fee is charged to the advertiser. Typically, the higher the cost per click offered, the higher and more prominent the advertisement may be displayed by the search engine. Other factors include target audience, likely target searches, total and daily budget, click through rate, and continuity of advertising and display, by way of non-limiting examples only. Such factors may contribute to some sites and/or advertisers being displayed more often and/or more prominently.

Pay per click advertising is thus a fast, effective and highly measurable way of generating business. According to an aspect of the present invention, a pop-up, banner, text ad or other similar type of link may be delivered using pay per click, pay per view, pay per sale models, or otherwise, and the present invention may make use of continuity of advertising between the advertisement and the text to improve the “success”, such as obtaining the desired view, click, or sale, respectively, of the ad.

For example, in current embodiments, if one delivers text ads via Google, with a keyword Nokia, when anyone searches “Nokia”, the underlying ad for a cell store may be delivered. This is done because, in this embodiment, a keyword, such as “Nokia”, has been sold. The website to which the ad click is directed to is the one that has purchased that keyword.

According to an aspect of the present invention, this system may include an interstitial engine that ties the keyword purchaser and the search engine together, thus creating an increase in the ease of use. In this configuration, if the keyword searched is Nokia, and the user clicks the ad and is directed to the website, the loading/front page that is displayed to this user should highlight Nokia phones because the click was initially related to a Nokia search, for example. In such a configuration, the product delivered and displayed may be specific to the endorser. This allows a broad spectrum of endorsers to be used with potentially competing products, such that, in the above example, the underlying web pages would not provide or emphasize all phones but rather those linked to the search term used.

In such an exemplary embodiment, different endorsers may be used to maximize the impact in a DMA, for example, such as instead of using a nationwide endorser such as Tiger Woods, for example. This may help control the underlying ad cost, while still providing similar success related to the endorsement through use of DMA impact endorsers who are cheaper than national endorsers. In other words, certain factors related to a profile of the searching user, such as geographic location of an IP address, or keywords in a search, such as “Nokia, Pennsylvania, dealers”, may lead to real-time modification of an ad placed on the search results page, and/or of any endorsements placed on the “clicked to” page to which the ad refers a clicking user. For example, in the event a search occurs for “Nokia, Pennsylvania, dealers”, a Nokia dealer's ad on the search results page may be endorsed by a player on the Philadelphia Phillies. In the event the desired click occurs, the front page loaded by that dealer may specifically emphasize Nokia phones, and may additionally include an endorsement from that Phillies player, or may include endorsement from another Pennsylvania-based endorser. Other search engines value only the click with no continuity, while the present invention focuses more on the valuable click and the display thereafter, which, when endorsed, has still greater value. This continuity thus appreciably increases the chances of success.

As will be apparent to those skilled in the art, the engines within the endorsed advertising engine of the present invention may draw on any number of communication access points and media sources, including wired and wireless, radio and cable, telephone, television and internet, personal electronic devices, satellite, databases, data files, and the like, in order to increase content in the vault, contribute content for intelligent selection of brand associations, and best allow for recommendations and delivery.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

We claim:

1. A system for delivering matched media asset, comprising:
a media vault to store a plurality of media assets;
a recommendation engine to select at least one of the plurality of media assets from the media vault; and
a delivery engine, remote to the recommendation engine, to receive the selected at least one media asset from the recommendation engine and to integrate the selected at least one media asset with a second media asset to form an integrated media asset for presentation to a user, wherein the integration is based on data intelligence collected at the delivery engine.

2. The system of claim 1, wherein the data intelligence is data used to prevent the selected at least one media asset from being repeatedly presented to the user.

3. The system of claim 1, wherein the delivery engine receives at least two selected media assets from the recommendation engine and further selects one of the at least two received media assets to integrate with the second media based on data intelligence.

4. The system of claim 3, wherein data intelligence comprises one of click-thru rate, post-click conversion rate, post-impression activities, geography, and demographic.

5. The system of claim 1, wherein the media vault and the recommendation engine are controlled by a first party and the delivery engine is controlled by a second party.

6. The system of claim 3, wherein the first and second parties are different parties.

7. The system of claim 3, wherein the first and second parties are same party.

8. The system of claim 1, the recommendation engine selects the at least one media asset based on at least one keyword received from the delivery engine.

9. The system of claim 8, wherein the keyword provided to the recommendation engine is generated by the delivery engine based on data intelligence collected at the delivery engine.

10. A method delivering matched media asset, comprising:
receiving a keyword, from a user device, at a recommendation engine;
selecting, using the recommendation engine, at least one of a plurality of media assets from a media vault using the received keyword;
sending the selected at least one media asset to the user device; and
at the user device, integrating the received selected media asset with a second media asset for presentation at the user device, wherein the integration is based on data intelligence collected at the user device.

11. The method of claim 10, wherein selecting the at least one of the plurality of media assets comprises selecting at least two media assets, using the recommendation engine, for sending to the user device, and
wherein the user device selects one of the two received media assets based on data intelligence for integrating with the second media asset.

12. The method of claim 10, wherein data intelligence comprises one of click-thru rate, post-click conversion rate, post-impression activities, geography, and demographic.

13. The method of claim 10, wherein the media vault and the recommendation engine are controlled by a first party and the delivery engine is controlled by a second party.

14. The method of claim 10, wherein the first and second parties are different parties.

15. The method of claim 10, further comprises preventing, at the user device, the media asset received from the recommendation engine to be integrated with the second media asset based on data intelligence to reduce redundant placement of the received media asset.

16. A system for delivering matched media asset, comprising:
a media vault to store a plurality of media assets;
a user device to receive a keyword from a user and to send the received keyword to a remote server;
a recommendation engine, located at the remote server, to select a first media asset from the plurality of media assets stored on the media vault and to send the first media asset to the user device,
a delivery engine, located at the user device, to receive the first media asset from the recommendation engine and to integrate the first media asset with a second media asset to form an integrated media asset for presentation to a user at the user device, wherein the keyword sent to the recommendation engine by the user device is generated based on data intelligence collected at the user device.

17. The system of claim 16, wherein the data intelligence is data used to prevent the first media asset from being repeatedly integrated with the second media asset and presented to the user.

18. The system of claim 16, wherein the remote server is controlled by a first party and the user device is controlled by a second party.

19. The system of claim 18, wherein the first and second parties are different parties.
